(19) United States
(12) Patent Application Publication
(10) Pub. No.: US 2009/0206537 A1
(43) Pub. Date: Aug. 20, 2009

(54) CLAMP WITH MOVEABLE GRIPPING PINS

(76) Inventors: Francis Vezina, Varennes (CA); Dominic Vezina, St-Basile-le-Grand (CA); Sylvain Vezina, St-Charles-sur-Richelieu (CA)

Correspondence Address: LADAS & PARRY LLP, 224 SOUTH MICHIGAN AVENUE, SUITE 1600, CHICAGO, IL, 60604, US

(21) Appl. No.: 12/367,880

(22) Filed: Feb. 9, 2009

Related U.S. Application Data
(60) Provisional application No. 61/006,944, filed on Feb. 7, 2008.

(51) Int. Cl. B25B 5/14

(52) U.S. Cl. 269/266

(57) ABSTRACT

A clamp device has a pair of clamping members that are reciprocally movable between clamping and unclamping positions so as to respectively clamp and unclamp objects therebetween. One or both of these of clamping members includes a plurality of separate and movable gripping members extending therefrom for engaging objects during clamping. When clamping an object, these gripping members are moved away from the clamping member that they extend from to a position defined by these gripping members abutting the object.

### CROSS-REFERENCE TO RELATED APPLICATIONS

The present application requests priority on U.S. Provisional Application No. 61/006,944 filed on Feb. 7, 2008 and incorporated herein by reference in its entirety.

### FIELD OF THE INVENTION

The invention generally relates to a clamp. More specifically but not exclusively, the invention relates to a clamp with moveable gripping pins.

### BACKGROUND OF THE INVENTION

Clamps are fastening or gripping devices which hold object tightly together to prevent movement or separation so as to be move. Clamp tools are used in a variety of different fields. For example clamps are quite common in the making of pre-cast concrete blocks. Usually, a plurality of pre-cast blocks defining a generally rectangular group or bundle of side-by-side blocks will be clamped at each side of the group so as to be handled.

In certain cases such groups or bundles of objects do not have uniform aligned sides but rather jagged surfaces. This makes them difficult to properly clamp them together.

### OBJECTS OF THE INVENTION

An object of the present invention is to provide a clamp with moveable gripping pins.

### SUMMARY OF THE INVENTION

In accordance with a non-limiting aspect of the present invention, there is provided a clamp device comprising:

a pair of clamping members being reciprocally movable between clamping and unclamping positions so as to respectively clamp and unclamp objects therebetween, at least one of the air of clamping members comprising a plurality of separate and movable gripping members extending therefrom for engaging objects during clamping,

wherein when clamping an object, the gripping members are moved away from the at least one clamping member to a position defined by the gripping members abutting the object.

In accordance with a non-limiting aspect of the present invention, there is provided, a clamping member for a clamp device having at least a pair of such clamping members for clamping objects therebetween, the clamping member comprising:

a longitudinal body defining a gripping side; and

a plurality of separate and movable gripping members extending from the gripping side for engaging objects during clamping,

wherein when clamping an object, the gripping members are moved away from the gripping side to a position defined by the gripping members abutting the object.

In accordance with the present invention, there is also provided a method for gripping a plurality of objects which are in a bundle and in which the bundle does not have perfectly aligned clamping sides, this method comprises applying a pressure on separate moveable gripping members so that they grippingly abut the sides of this bundle along the contour thereof.

The foregoing and other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

FIG. 1 is a perspective front view of the clamp in accordance with a non-restrictive illustrative embodiment of the present invention;

FIG. 2 is a front elevational view of the clamp of FIG. 1;

FIG. 3 is a top plan view of the clamp of FIG. 1;

FIG. 4 is a side elevational view of the clamp of FIG. 1;

FIG. 5 is a sectional view of the clamp of FIG. 1 along line 5-5 thereof;

FIG. 6 is a side elevational view of the sectional view of FIG. 5;

FIG. 7 is a top plan view of the clamp of FIG. 1 engaging objects during clamping;

FIG. 8A is 8B are top plan views of a clamp device clamp in accordance with a non-restrictive illustrative embodiment of the present invention, showing the clamp deice in the unclamping and clamping positions respectively;

FIG. 9 is a block diagram of a controller for controlling a plurality of actuators, each actuator controlling a given gripping member of a clamp in accordance with a non-restrictive illustrative embodiment of the present invention.

### DETAILED DESCRIPTION OF ILLUSTRATIVE EMBODIMENTS

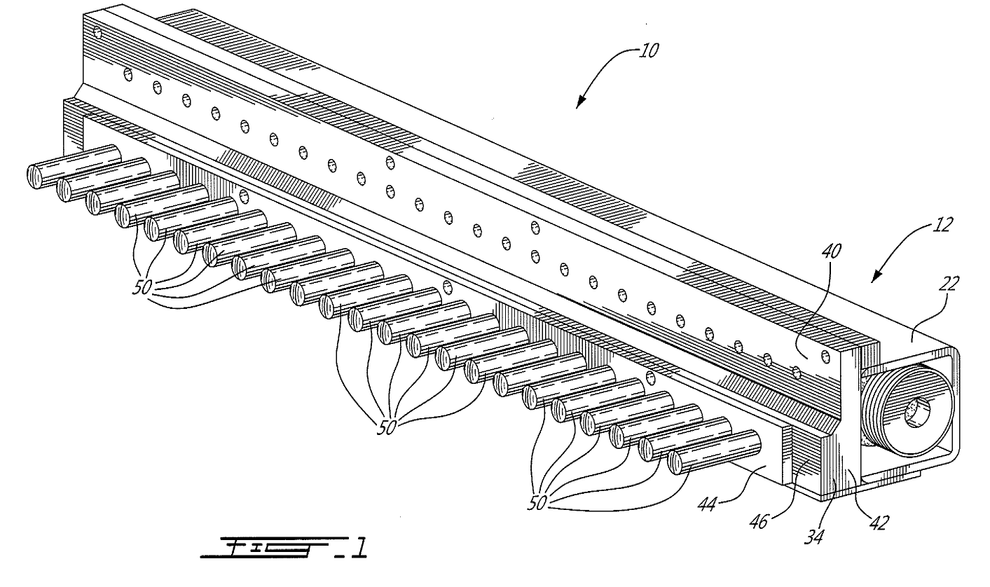

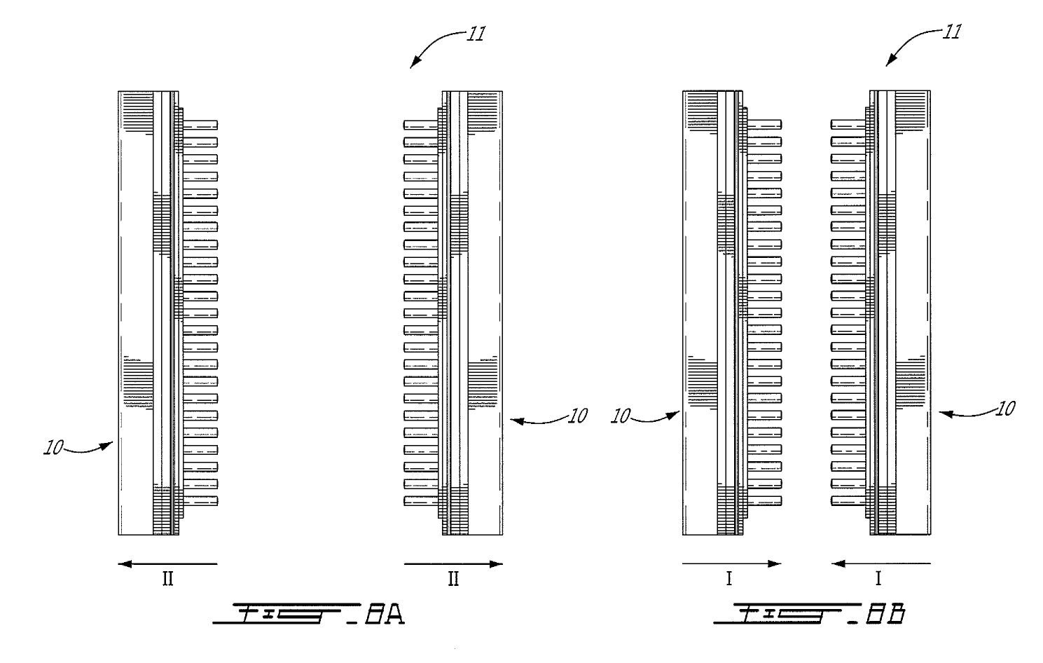

FIG. 1 shows a clamp member 10 in accordance with a non-restrictive illustrative embodiment of the present invention. A pair of clamp members 10 adjacently positioned in a spaced apart fashion so as to grip objects therebetween define a clamp device 11 (see FIGS. 8A and 8B) in accordance with a non-restrictive illustrative embodiment of the present invention.

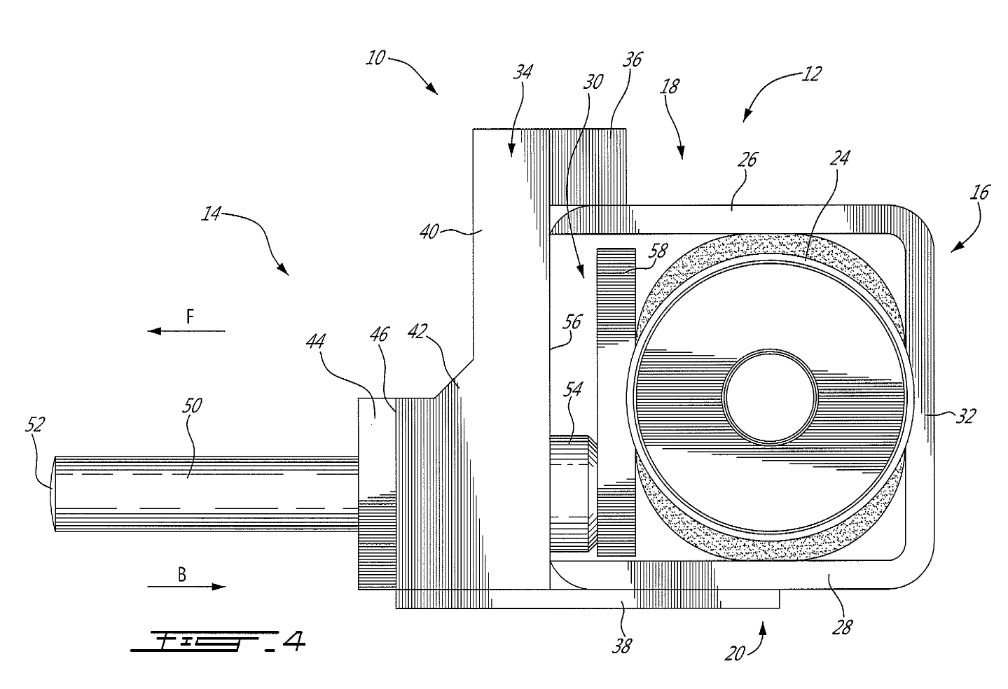

The clamp 10 includes a longitudinal body 12. As better shown in FIG. 4, the longitudinal body 12 defines a front gripping side 14 and an opposite rear side 16 as well as a top side 18 and an opposite bottom side 20.

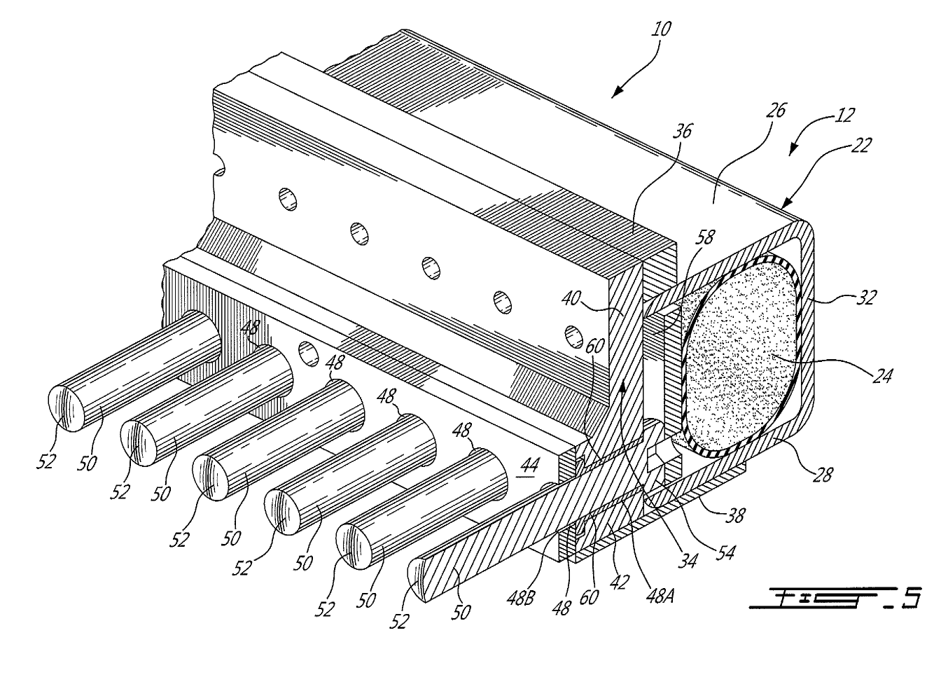

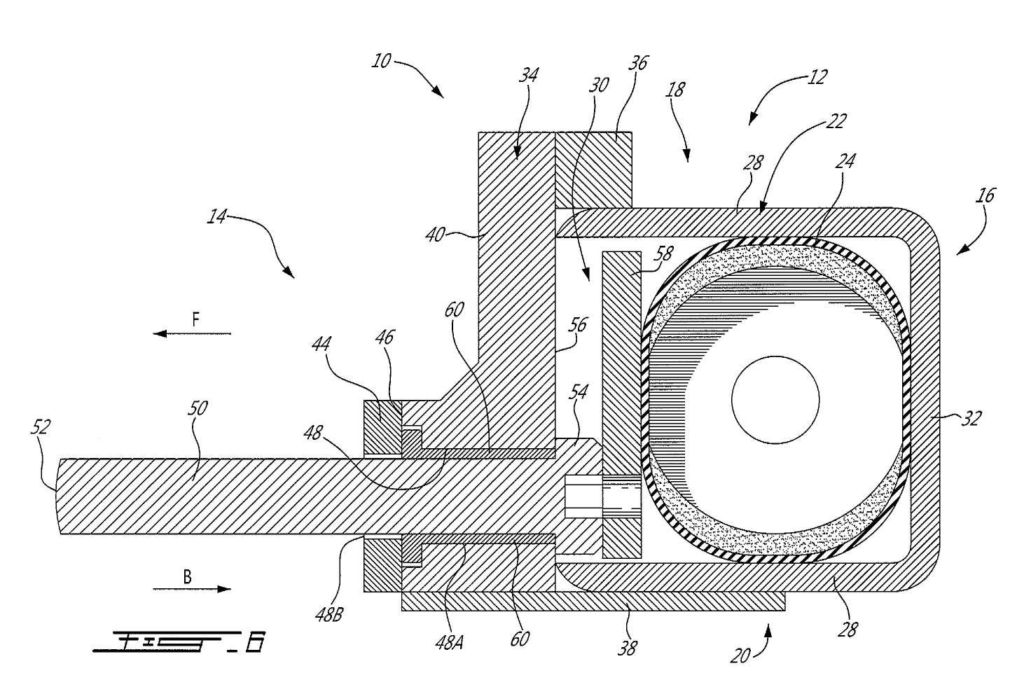

The longitudinal body 12 includes a main body portion 22 in the form of a longitudinal C-shaped housing for carrying an actuator 24 therein. As better shown in FIGS. 4, 5 and 6 the main body portion 22 includes top and bottom walls 26 and 28, and open front side 30 (see FIGS. 4 and 6) as well as a back wall 32.

A front body portion 34 is mounted the main body portion 22 so as to cover the open front face 30 thereof.

Turning back to FIGS. 4, 5 and 6, the front body portion 34 includes a top connector 36, connected to the top wall 26 of the main body portion 22, and a bottom connector 38 connected to the bottom wall 28 of the main body portion 22. The front body portion 34 includes a top elongated section 40 and a short thicker bottom section 42. The thicker bottom section 42 includes a longitudinal plaque 44 mounted on its front face 46. The thicker bottom section 42 includes a plurality of separate apertures 48A which are aligned with like apertures 48B formed in the plaque thereby defining a common hole 48 extending from the open front face 40 of the main body portion 22 to the gripping side 14. Each hole 48 provides for carrying a movable gripping member 50 in the form of a generally cylindrical finger or pin.

In this way, a plurality of movable gripping pins 50 extend from the front gripping side 14 of the clamp member 10.

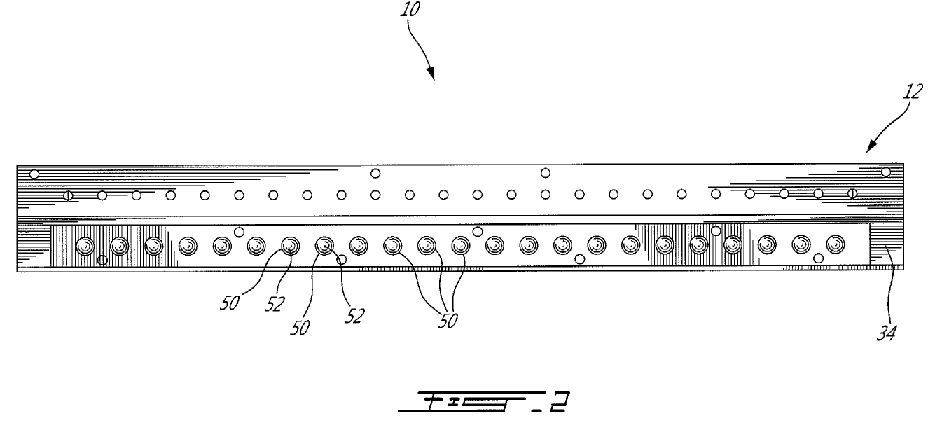

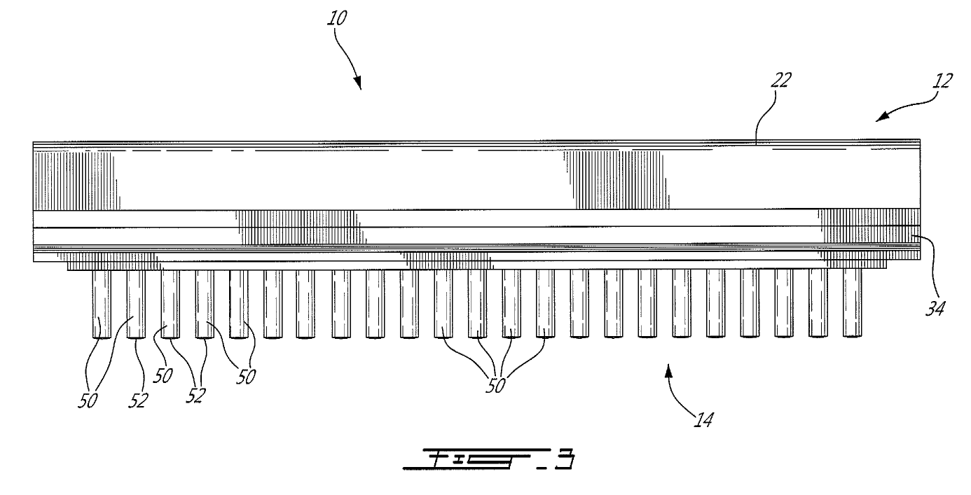

As shown in FIGS. 4, 5 and 6, each gripping pin 50 includes a distal clamping end 52 (also see FIGS. 2 and 3) as well as a proximal stopper end 54. The stopper end 54 is in the form of a larger cylindrical head which has a diameter greater than that of a given hole 48 thereby abutting the internal wall 56 of the front body portion 34 when moved thereto. Each stopper head 54 is connected to a moveable plaque 58 that is in communication with the actuator 24. Furthermore, each movable gripping pin 50 is positioned within a sleeve bushing 60 provided within the holes 40 so as to be slidably moveable therein in a forward and backward position as respectively shown by arrows F and B in FIGS. 4 and 6.

The actuator 24 in this example is a longitudinal pressure controlled hose which can be selectively inflated and deflated via pressure. The plaque 58 of each gripping pin 50 is so connected to the pressure control actuator hose 24 so as to be moved forwards (arrow F) during inflation of the actuator 24 or backwards (arrow B) during deflation of the actuator 24. In this way, the movable gripping pin 50 is caused to move forward F extending from the gripping side 14 during clamping to a maximum forward position determined by the stopper 54 abutting the wall 56 or to move backward B during unclamping further into the longitudinal body 12.

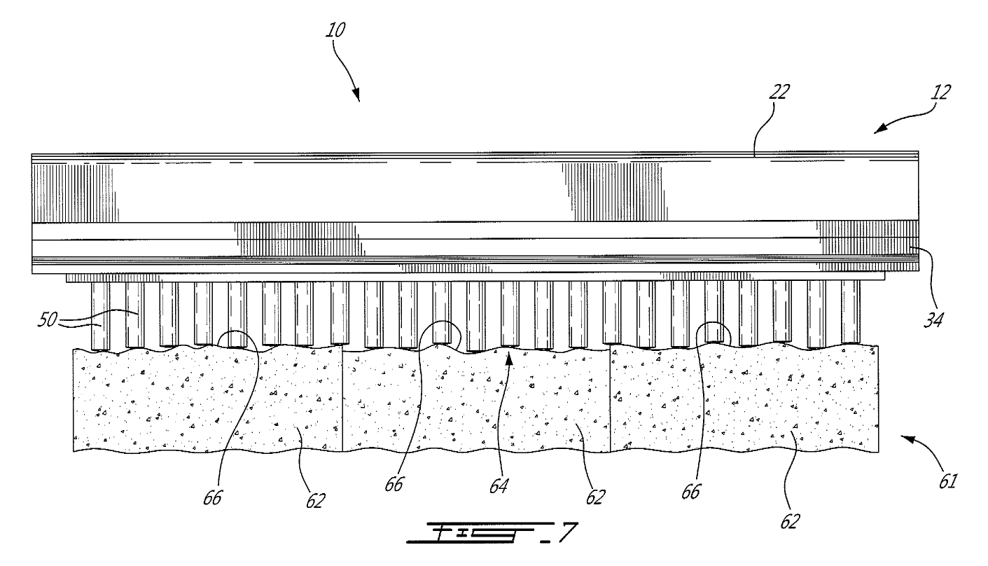

Turning now to FIGS. 7, 8A and 8B, in operation a pair of such clamp members 10 of a clamp device 11 move towards each other (as shown by arrows I) to grip therebetween a plurality of side-by-side objects in a bundle or group such as a plurality 61 of blocks 62, shown in FIG. 7 defining opposite side surfaces 64 which are engaged by the gripping pins 50 (specifically by the distal ends 52). Since these objects 62 are not positioned in perfect alignment or do not have straight respective sides 66, the side surfaces 64 of the bundle 61 is jagged or non-uniform. Hence, during clamping each pin 50 will move outwardly (arrow F) to a distance determined by the distal end 52 clampingly abutting the surface of an object at the aforementioned gripping or clamping side. Hence, the distal gripping ends 52 will be aligned with the contour of a given gripping clamping side of the bundle or group pf objects. In order to release the objects 62 from the device 11, the clamping members 10 are moved away from each other as shown by arrows II in FIG. 8A.

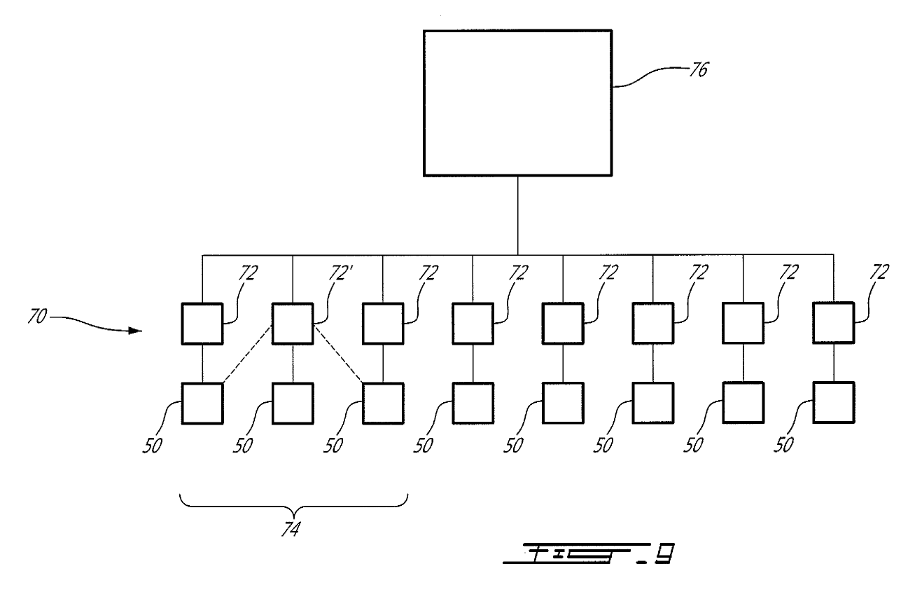

Turning now to FIG. 9, In another non-restrictive illustrative embodiment, the actuator 24 is replaced by an actuator assembly 70 comprising a plurality of separate actuators 72. Each of these separate actuators is in communication with the separate plaque 58 or like-backing for controlling the movement of a given gripping member 50. In a further example, a given separate actuator, such as actuat 72′ may control a plurality of the gripping members 50 along a section 74 of the gripping side. The actuator assembly 70 may be linked to a controller such as processor for example to control gripping in a more precise manner. In this way, the user has greater control of the pressure applied to groups of gripping members or individual gripping members. Furthermore, the actuator of the present invention can be a pressured control actuator, this pressure can be provided by air or liquid. Of course, a variety of different types of actuators can be used within the context of the present invention.

It should also be understood that the gripping members can be provided in a variety of configurations and can be in the form of short plaques, plates, fingers, pins, rods, protrusions and the like as the skilled artisan will contemplate within the scope of the present invention.

The present invention therefore provides a clamp in a form of a clamp member or clamp device which is to be included in a variety of other devices such as robotic arms for example as well as a clamping method.

Although the present invention has been described hereinabove by way of illustrative embodiments thereof, these embodiments can be modified at will, within the scope of the appended claims, without departing from the spirit and nature of the present invention.

What is claimed is:

1. A clamp device comprising:
a pair of clamping members being reciprocally movable between clamping and unclamping positions so as to respectively clamp and unclamp objects therebetween, at least one of said pair of clamping members comprising a plurality of separate and movable gripping members extending therefrom for engaging objects during clamping,
wherein when clamping an object, said gripping members are moved away from said at least one clamping member to a position defined by said gripping members abutting the object.

2. A clamp device according to claim 1, wherein both said camping members comprise a plurality of separate and movable gripping members respectively extending therefrom for engaging objects during clamping.

3. A clamp device according to claim 1, wherein said at least one clamping member comprises a longitudinal body defining a gripping side, said plurality of gripping members extending from said gripping side.

4. A clamp device according to claim 3, wherein said gripping side comprises a plurality of separate apertures, each said gripping member extending through a respective said aperture.

5. A clamp device according to claim 4, wherein said gripping members are movable in a forward and backward direction through their respective said apertures.

6. A clamp device according to claim 5, wherein bushings are positioned within said bushing to provide said gripping members to be slidably movable therethrough.

7. A clamp device according to clam 5, wherein said gripping members are longitudinal members having a respective claming end external to said longitudinal body and an opposite end housed within said longitudinal body, said opposite stopper end comprising being larger than said aperture for abutting an internal surface of said longitudinal body when being moved in the forward direction.

8. A clamp device according to claim 3, wherein said gripping members are mounted to a movable plaque housed within said longitudinal body.

9. A clamp device according to claim 8, wherein said plaque is mounted to an actuator housed within said longitudinal body.

10. A clamp device according to claim 9, wherein said actuator comprises a pressure controlled member.

11. A clamp device according to claim 1, wherein said gripping member are mounted to an actuator for being moved thereby.

12. A clamp device according to claim 7, wherein said gripping members are mounted to said actuator via a movable plaque positioned therebetween.

13. A clamp device according to claim 1, wherein each said gripping member is mounted to a respective actuator for independent movement thereof.

14. A clamp device according to claim 1, wherein said gripping members comprise pin members.

15. A clamping member for a clamp device having at least a pair of such clamping members for clamping objects therebetween, said clamping member comprising:
a longitudinal body defining a gripping side; and
a plurality of separate and movable gripping members extending from said gripping side for engaging objects during clamping,
wherein when clamping an object, said gripping members are moved away from said gripping side to a position defined by said gripping members abutting the object.

16. A clamping member according to claim 15, wherein said gripping side comprises a plurality of separate apertures, each said gripping member extending through a respective said aperture.

17. A clamping member according to claim 16, wherein said gripping members are movable in a forward and backward direction through their respective said apertures.

18. A claming member according to claim 17, wherein bushings are positioned within said apertures to provide said gripping members to be slidably movable therethrough.

19. A clamping member according to clam 17, wherein said gripping members are longitudinal members having a respective clamping end external to said longitudinal body and an opposite end housed within said longitudinal body, said opposite stopper end comprising being larger than said aperture for abutting an internal surface of said longitudinal body when being moved in the forward direction.

20. A clamping member according to claim 15, wherein said gripping member are mounted to an actuator for being moved thereby.

21. A clamping member according to claim 20, wherein said gripping members are mounted to said actuator via a movable plaque positioned therebetween.

22. A clamping member according to claim 15, wherein each said gripping member is mounted to a respective actuator for movement thereof.

23. A clamping member according to claim 15, wherein said gripping members comprise pin members.
